(19) United States
(12) Patent Application Publication
(10) Pub. No.: US 2008/0037528 A1
(43) Pub. Date: Feb. 14, 2008

(54) Persistent Confirmed Configuration Method

(76) Inventors: Alexander Lindeijer, Heggedal (NO); Per Erik Moldskred Nissen, Drammen (NO)

Correspondence Address: ERICSSON INC., 6300 LEGACY DRIVE, M/S EVR 1-C-11, PLANO, TX, 75024, US

(21) Appl. No.: 11/576,791

(22) PCT Filed: Oct. 8, 2004
(86) PCT No.: PCT/NO04/00302

§ 371 Date: Apr. 5, 2007

(51) Int. Cl. H04L 12/66

(52) U.S. Cl. 370/354

(57) ABSTRACT

The invention relates to systems and methods for remote configuration updating of network elements. One of the features of the invention being the classification of configuration changes/updates to the equipment. Depending on the class of the configuration change it is handled in a different way, i.e. non-volatile storage directly or after manual/automatic confirmation of the configuration with a certain confirm time. Not confirming within the confirm time leads to re-establishment of the configuration for with the equipment had remote access.

### FIELD OF THE INVENTION

The invention relates to updating/changes of network elements within data and/or telecommunication. More particularly it relates to a system and a method for remote configuration of one or more network elements over a packet switched network.

### BACKGROUND OF THE INVENTION

Data/telecom equipment is often managed remotely by sending commands over a DCN (Data Communication Network) as shown in FIG. 1. However remote configuration changes/updates can lead to missing contact with the equipment over the DCN. In that case an operator has to travel to the site where the equipment is located, which is both cumbersome and expensive.

In existing data/telecom equipment configuration there are mainly two ways to perform configuration changes/updates:
1.a Changes/updates are made to a volatile running configuration and need to be saved non-volatile explicitly by means of a “save” command. The equipment will then use the non-volatile configuration upon restart/power-up. This means that a restart, due to some kind of equipment failure, will not perform volatile configuration.
1.b Changes/updates in the configuration are directly made non-volatile. A restart will always lead to a state that incorporates the last configuration changes/updates.

Both methods however have the disadvantage that they don't recover from “unintended” mis-configuration.
a. When in method “1a” a configuration leads to loss of remote access to the equipment, the “save” command cannot be ordered, so the configuration changes/updates cannot be made persistent. A fallback to the configuration state where remote access was possible will only occur with a restart, which should seldom occur, activates the non-volatile configuration.
b. Making configuration automatically non-volatile, as in method “1b”, means that a configuration that disrupts remote access will always be activated, leading to not-accessible equipment.

To overcome some of the problems above LM Ericsson AB has shown for a system operating with microwave transmission technology, the Mini Link Traffic Node™ Release 1, use of method “1a” with the rule that the equipment performs a restart, and the latest non-volatile configuration is reloaded, if a configuration change command isn't followed by another command within a certain period of time (Tsave). A “save” command then makes the configuration non-volatile.

Use of the method depicted in the section above results in the following problems;
the operator(s) have to send many “save” commands since every configuration change/update have to be “saved”
operator(s) may “forget” to save a configuration
the network element(s) misses the configuration due to restart following after expiration of the time period.

### SUMMARY OF THE INVENTION

It is an object of the present invention to provide a method avoiding the above described problems.

The features defined in the independent claims enclosed characterize this method.

In particular, the present invention provides

### BRIEF DESCRIPTION OF THE DRAWINGS

In order to make the invention more readily understandable, the discussion that follows will refer to the accompanying drawing.

FIG. 1 shows an example of equipment accessed remote by means of a DCN,

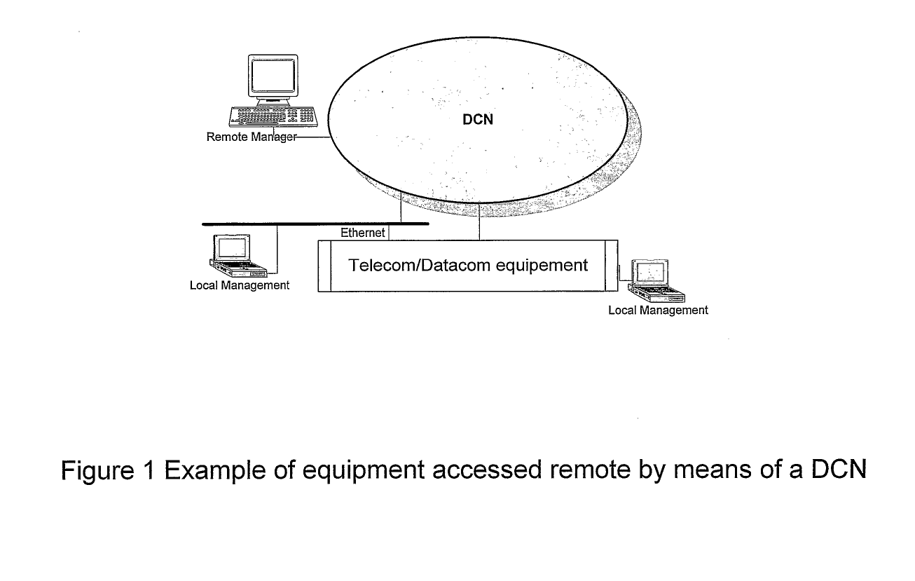

FIG. 2 shows configuration method a: manual save no fallback,

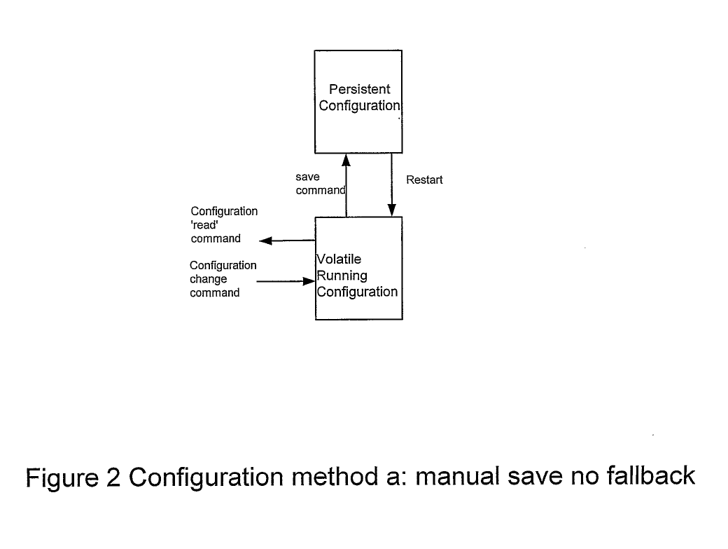

FIG. 3 shows a message sequence chart (MSC) method a: manual save no fallback,

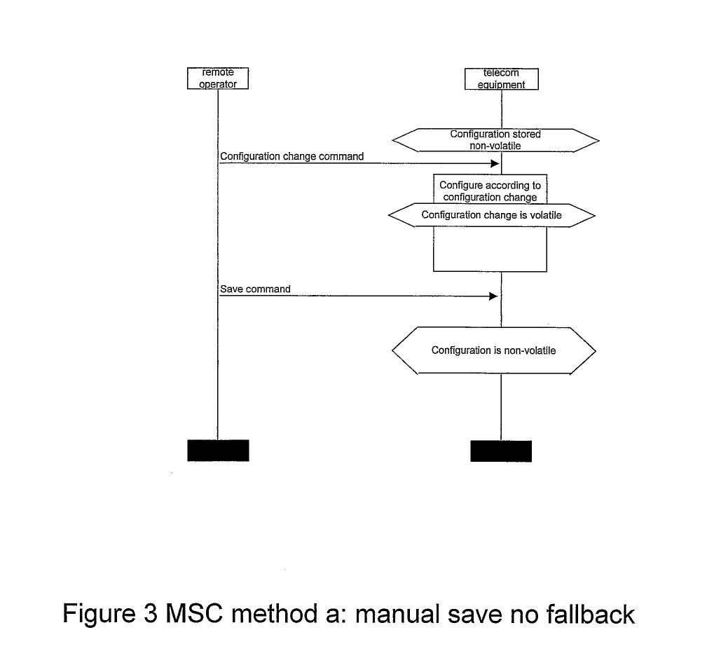

FIG. 4 shows configuration method b: Automatic save no fallback,

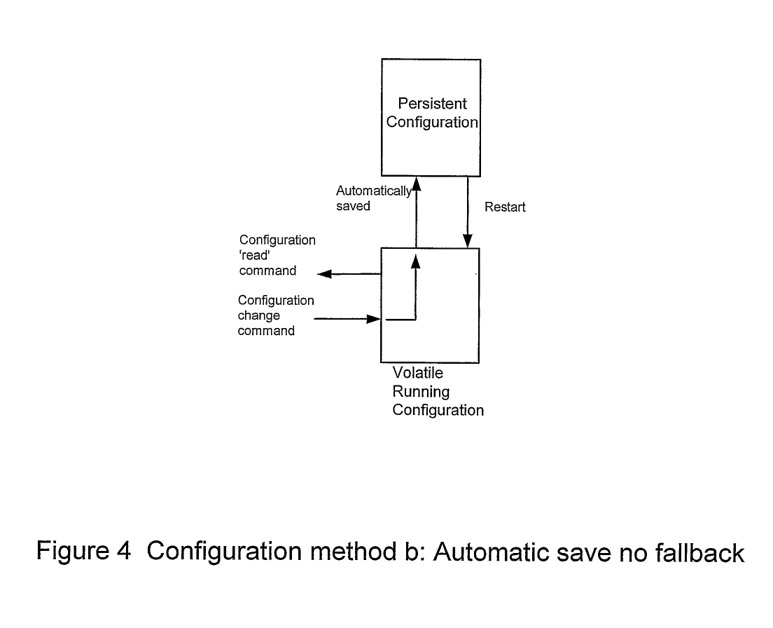

FIG. 5 MSC method b: Automatic save no fallback,

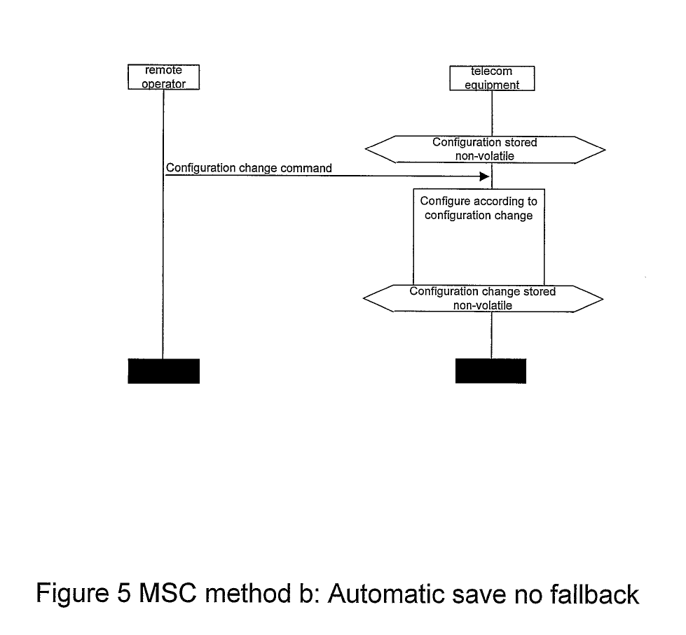

FIG. 6 MSC Configuration save in ML-TN Release 1

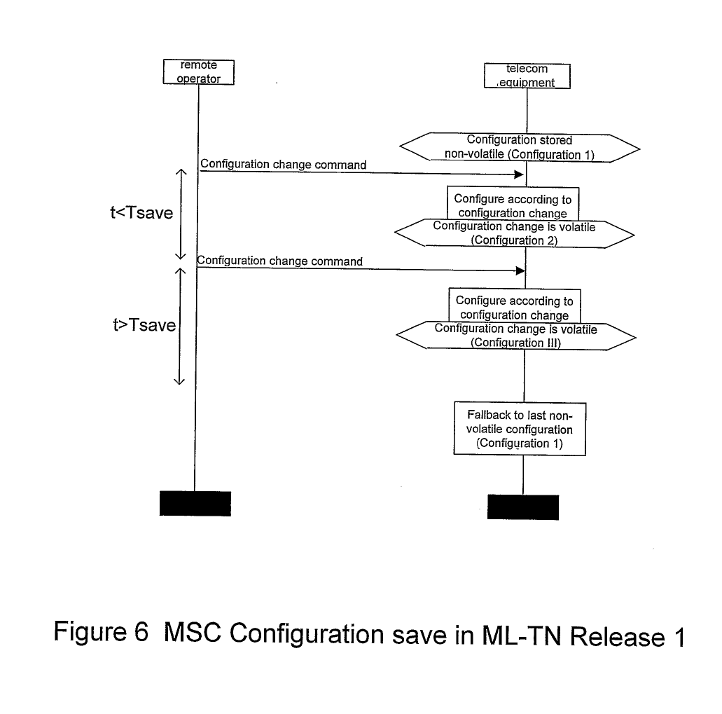

FIG. 7 shows configuration Handling Functional model,

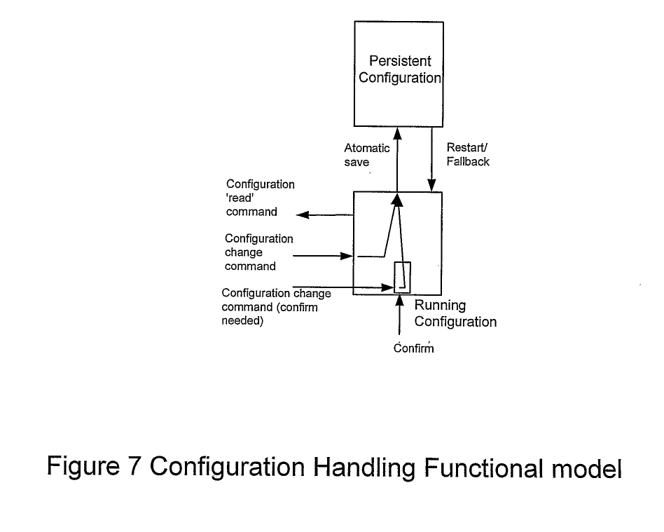

FIG. 8 shows an example MSC of configuration changes/updates for Class I and II

### DETAILED DESCRIPTION OF THE INVENTION

According to the present invention a method and a system is introduced that only needs the “save” command for configuration changes/updates that really can disrupt remote access to the equipment during configuration updates. All other configuration changes/updates are stored non-volatile automatically.

A Major principle for the present invention is the classification of configuration changes/updates to the equipment. Depending on the class of the configuration change it is handled in a different way, i.e. non-volatile storage directly or after manual/automatic confirmation of the configuration with certain confirm time. Not confirming within the confirm time leads to re-establishment of the configuration for which the equipment had remote access.

An enhancement of the invention is that in case a configuration needs to be confirmed in order to verify DCN connectivity that the equipment automatically tries to establish a connection, e.g. a ping command is sent to an IP-address.

### DETAILED TECHNICAL DESCRIPTION OF THE INVENTION

The “save” command as known from the above mentioned Mini Link Traffic Node™ Release 1, from Telefonaktiebolaget L.M. Ericsson AB had actually two intentions:
2.a Confirmation that remote access to the equipment still existed.
2.b Saving the volatile running configuration to a non-volatile start-up configuration.

The two intentions above are, according to the present invention separated into a confirmation command and an automatic non-volatile storage of configuration changes/updates. Not receiving a “confirm” command within a certain time (Tconfirm) leads to a restart and fall-back to the last non-volatile configuration that re-establishes remote contact with the equipment.

Only configuration changes/updates that can disrupt remote access to the equipment needs to be confirmed. As long as this kind of configuration is not confirmed the configuration will be volatile.

Consequently, a classification system for the configuration commands can be a tool for flexible and neat handling of such commands, thus avoiding the problems known from the prior art. The configuration changes/updates can be classified as shown in table 1. Persistence means that configuration must survive a restart of the NE. Whilst confirm means that the configuration can lead to lost of DCN connection and therefore needs some kind of check from the operator or the network element itself for DCN access.

TABLE 1
Configuration classification

| | Persistent | Non persistent |
|---|---|---|
| Confirm | Class I | Class III |
| Non-confirm | Class II | Class IV |

I. Persistent-Confirm Changes/updates that need to be persistent and confirmed, e.g. ip-address, loop on a traffic interface carrying DCN. A fallback is performed if the changes/updates are not confirmed within a specified time interval.
II. Persistent-nonConfirm Changes/updates that need to be persistent but not confirmed, e.g. cross-connects. These changes/updates can be made persistent immediately without interference of the operator/manager.
III. nonPersistent-Confirm Changes/updates that need not to be persistent but confirmed.
IV. nonPersistent-nonConfirm Changes/updates that neither need to be persistent nor confirmed, e.g. set of an activation object for configuration load. These aren't actual configuration changes/updates. These are configuration commands used to perform an action. For these “changes/updates” nothing has to be done.

This means that persistency and confirmation of a configuration are in principle two independent dimensions that should not be implemented by one command because that covers only the class I.

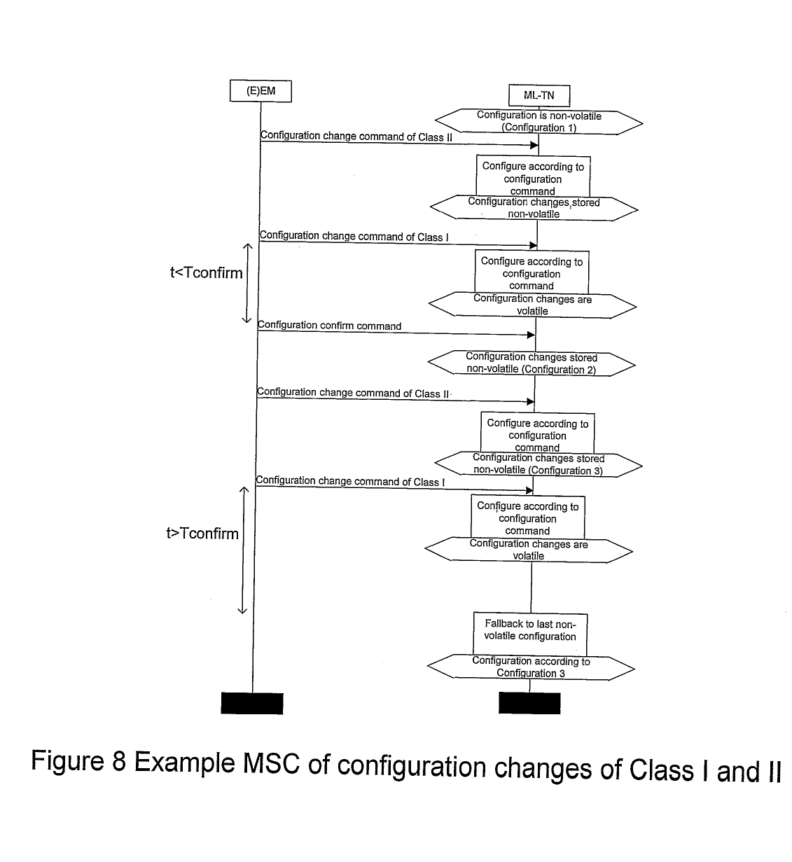

FIG. 8 shows an example MSC (Message Sequence Charts) for configuration changes/updates that do and don't require a confirmation.

### IMPLEMENTATION OF A PREFERRED EMBODIMENT OF THE INVENTION

In the prior art the non-volatile configuration was stored as one big file occupying a number of reserved sectors in the flash memory.

According to the present invention the saving of the configurations will happen automatically and it will happen more often. In order to minimize the expenditure of time for storing of configurations and to reduce wear-out of the flash memory configurations are divided into several small files using JFFS (Journaling Flash File System 2).

### ADVANTAGES OF THE INVENTION

Advantages of the invention over other solutions are:
3.a The vast majority of the configuration changes/updates are made non-volatile automatically. The operator doesn't need to and cannot forget issue the “save” command.
3.b For specific configuration commands a fallback mechanism prevent the operator from missing remote access to the equipment.
3.c Saving the running configuration could take quite some time since the whole configuration is stored. According to the present invention only a small part of the configuration is stored, which takes less time.

Note that while in the foregoing, there has been provided a detailed description of particular embodiments of the pre-sent invention, it is to be understood that equivalents are to be included within the scope of the invention as claimed.

Abbreviations

| DCN | Data Communications Network |
|---|---|
| IP | Internet Protocol |
| JFFS2 | Journaling Flash File System 2 |
| ML-TN | MINI-LINK Traffic Node |
| NE | Network Element |
| SNMP | Simple Network Management Protocol |
| Tconfirm | Time in which configuration changes/updates of |
| | Class I and III need to be confirmed in order not |
| | to fall back to the old configuration. (ML-TN |
| | Release 2) |
| Tsave | Time in which the equipment needs to receive a |
| | new command or a save command in order not to |
| | fall back to the old configuration. (ML-TN Release |
| | 1) |

1. System for remote configuration of one or more network elements over a packet switched communication network where the one or more network elements are adapted to selectively and automatically save configuration updates
characterized in that the system is adapted to handle one or more commands for the configuration, where the one or more commands for the configuration are classified into at least a first configuration class I, and a second configuration class II, where the first configuration class I comprises one or more configuration commands that needs to be persistent and confirmed by an operator or the one or more network elements, the second configuration class II comprises one or more configuration commands that needs to be persistent but not confirmed by the operator or the one or more network elements.

2. System according to claim 1,
characterized in that the system is adapted to handle four configuration classes the first class named I, the second class named II, a third class named III and a fourth class named IIII.

3. System according to claim 1,
characterized in that, the system is adapted to identify the four classes, namely class I, Class II, class III and class IV using the following characteristics for the configuration commands:
a. the configuration class I is identified by configuration commands that are/is persistent and must survive a restart of the one or more network elements, and where the configuration command traffic is affecting network connection, and
b. the configuration class II is identified by configuration commands that are/is persistent and must survive a restart of the one or more network elements, and where the network connection is unaffected by the configuration command traffic, and
c. the configuration class III is identified by configuration commands that are/is non-persistent and don't have to survive a restart of the one or more network elements, and where the configuration command traffic is affecting network connection, and,
d. the configuration class IV is identified by configuration commands that are/is non-persistent and don't have to survive a restart of the one or more network elements and where the network connection is unaffected by the configuration command traffic.

4. System according to claim 2,
characterized in that the system is adapted to execute the two following scenarios for configuration commands:
a. a save scenario for each of the classes where configuration commands are made non volatile
b. a fallback scenario for class I and III where configuration commands are volatile and the one or more network elements performs a fallback to the last non volatile configuration.

5. System according to claim 2,
characterized in that the system is further adapted to perform the following actions when the configuration commands is/are of class I:
a. a first sender is adapted to forward a configuration command of class I to one or more network elements, the one or more network elements are adapted to start a first timer having a first expiration period, simultaneously or substantially simultaneously the one or more network elements are adapted to start the configuration according to the configuration command, the first sender is adapted to forward a configuration confirm command to the one or more network elements before expiration of the first expiration period, the one or more network elements is/are adapted to store the configuration changes/updates to a non volatile memory, or
b. a first sender is adapted to forward a configuration command of class I to one or more network elements, the one or more network elements are adapted to start a first timer having a first expiration period, simultaneously or substantially simultaneously the one or more network-element are adapted to start a configuration according to the configuration command, simultaneously or substantially simultaneously as the first expiration period expires without any confirmation command received at the one or more network elements, the one or more network elements are adapted to perform a fallback to the last non volatile configuration.

6. System according to claim 2,
characterized in that class I includes commands using parameters as IP-address.

7. System according to claim 2,
characterized in that the system is further adapted to perform the following actions when the configuration commands is/are of class II:
a first sender is adapted to forward a configuration command of class II to one or more network elements, simultaneously or substantially simultaneously the one or more network elements is adapted to start a configuration according to the configuration command, the one or more network elements is adapted to store the configuration changes/updates to a non volatile memory.

8. System according to claim 2,
characterized in that update commands includes cross connect commands.

9. System according to claim 1,
characterized in that the system is adapted to divide the configuration commands into more than one file.

10. System according to claim 9,
characterized in that system is adapted to divide the configuration commands into more than one file using JFFS.

11. System according to claim 1,
characterized in that the one or more network elements can be one of the following:
one or more Traffic nodes,
one or more DXCs, Digital Cross Connects,
one or more ADM's, add drop multiplexers,
one or more TM's, Terminal Multiplexers,
one or more data communication hubs,
one or more data or telecommunication switches, and
one or more data or telecommunication routers.

12. System according to claim 1,
characterized in that the communication network is a DCN.

13. A method for remote configuration of one or more network elements over a packet switched communication network where the one or more network elements selectively and automatically saves configuration updates characterized in that the system executes one or more commands for the configuration, classifying the one or more commands for the configuration into at least a first configuration class I, and a second configuration class II, where the first configuration class I comprises one or more configuration commands that needs to be persistent and confirmed by an operator or the one or more network elements, the second configuration class II comprises one or more configuration commands that needs to be persistent but not confirmed by the operator or the one or more network elements,

14. Method according to claim 13,
characterized in that the system is handles four configuration classes the first class named I, the second class named II, a third class named III and a fourth class named IIII.

15. Method according to claim 13,
characterized in that, the system is identifies the four classes, namely class I, Class II, class III and class IV using the following steps:
a. identifying the configuration class I by configuration commands that are/is persistent and must survive a restart of the one or more network elements, and where the configuration command traffic is affecting network connection, and
b. identifying configuration class II by configuration commands that are/is persistent and must survive a restart of the one or more network elements, and where the network connection is unaffected by the configuration command traffic, and
c. identifying configuration class III by configuration commands that are/is non-persistent and don't have to survive a restart of the one or more network elements, and where the configuration command traffic is affecting network connection, and,
d. identifying configuration class IV by configuration commands that are/is non-persistent and don't have to survive a restart of the one or more network elements and where the network connection is unaffected by the configuration command traffic.

16. Method according to claim 13,
characterized in that the system executes the two following scenarios for configuration commands:
c. a save scenario for each of the classes where configuration commands are made non volatile, and
d. a fallback scenario for class I and III where configuration commands are volatile and the one or more network elements performs a fallback to the last non volatile configuration.

17. Method according to claim 13,
characterized in that the system is perform the following steps when the configuration commands is/are of class I:
a. a first sender forwards a configuration command of class I to one or more network elements, the one or more network elements starts a first timer having a first expiration period, simultaneously or substantially simultaneously the one or more network elements starts the configuration according to the configuration command, the first sender forwards a configuration confirm command to the one or more network elements before expiration of the first expiration period, the one or more network elements stores the configuration changes/updates to a non volatile memory, or
b. a first sender forwards a configuration command of class I to one or more network elements, the one or more network elements starts a first timer having a first expiration period, simultaneously or substantially simultaneously the one or more network element starts a configuration according to the configuration command, simultaneously or substantially simultaneously as the first expiration period expires without any confirmation command received at the one or more network elements, the one or more network elements performs a fallback to the last non volatile configuration.

18. Method according to claim 13,
characterized in that the system perform the following steps when the configuration commands is/are of class II:
a first sender forwards a configuration command of class II to one or more network elements, simultaneously or substantially simultaneously the one or more network elements starts a configuration according to the configuration command, the one or more network elements stores the configuration changes/updates to a non volatile memory.
